(19) United States
(12) Patent Application Publication
(10) Pub. No.: US 2011/0276433 A1
(43) Pub. Date: Nov. 10, 2011

(54) FACILITATING THE EXECUTION OF TRANSACTIONS BETWEEN CUSTOMERS AND PROVIDERS

(75) Inventors: Andrew L. Burgess, JR., Desert Hills, AZ (US); Jerrald D. Naumann, Phoenix, AZ (US); David A. Sullivan, Chandler, AZ (US)

(73) Assignee: TRIBUNAL SYSTEMS, INC., Desert Hills, AZ (US)

(21) Appl. No.: 13/188,781

(22) Filed: Jul. 22, 2011

Related U.S. Application Data
(62) Division of application No. 11/955,634, filed on Dec. 13, 2007.

(51) Int. Cl. G06Q 30/00

(52) U.S. Cl. 705/26.81

(57) ABSTRACT

Methods (74, 76, 78) utilizing a network (20) of computing systems (22) facilitate execution of a transaction (114) between a consumer (38) and a provider (32). Preference data (108) defined by the consumer (38) is stored (76) in a database (82). When a request for the transaction (114) is detected at a transaction site (46), a consumer identifier (104) for the consumer (38) is utilized at the transaction site (46) to retrieve (220) the preference data (108) from the database (82). The preference data (108) identifies one or more products (96) offered by the provider (32) and preferred by the consumer (38). The transaction is performed (232) at the transaction site (46) to provide the product (96) to the consumer (38) in response to the retrieved preference data (108).

### RELATED INVENTION

The present invention is a divisional of “Facilitating the Execution of Transactions Between Customers and Providers,” U.S. patent application Ser. No. 11/955,634, filed 13 Dec. 2007, which is incorporated by reference herein.

### TECHNICAL FIELD OF THE INVENTION

The present invention relates to the field of consumer sales and service. More specifically, the present invention relates to facilitating the execution of transactions between consumers and providers based on consumer preferences.

### BACKGROUND OF THE INVENTION

With advances in the Internet, global communications, and transportation, consumers have more choices than ever before when it comes to purchasing a product (good or service). The ease with which consumers can make purchases has driven providers (i.e., retailers, vendors, service providers, electronic commerce media website, etc.) to fiercely compete for consumers' attention, trust, and retention.

One means of competition is the provision of high-quality customer service to consumers before, during, and after a transaction. Exceptional customer service requires a high level of contact, communication and coordination with the consumer. In order to deliver high-quality customer service, a provider needs to know the preferences of the individual consumers being served in order to deliver service that, in addition to being efficient, is also personal and effective in fulfillng their total service requirements.

Consequently, providers have endeavored to find techniques to communicate, interact, and provide personalized service to consumers in order to create an enriched transaction experience and improve consumer loyalty. Moreover, many providers endeavor to provide a consistent, quality service experience regardless of the channel consumers choose to use when they shop.

Toward this end, emerging technologies are directed. toward arming providers with opportunities to offer consumers personalized information and shopping experiences in a multitude of transaction. environments, while achieving the level of customer intimacy attained in traditional point-of-sale retail settings. Such techniques can increase consumer acquisition and retention rates ultimately increasing growth, revenues, and profit.

Unfortunately, many providers do not collect consumer specific information that can he used to deliver personalized service. Moreover, those who do, have typically not put that consumer specific information to good use in their business. Furthermore, there are no known techniques for centralizing consumer specific preference information for a plurality of providers and for facilitating a consumer's participation in the collection of preference information for a plurality of providers.

### SUMMARY OF THE INVENTION

Accordingly, it is an advantage of the present invention that a method, executable code, and system are provided for facilitating the execution of a transaction between a consumer and a provider.

It is another advantage of the present invention that a method, executable code, and system are provided that enable a provider to offer personalized service to a consumer for enhanced levels of consumer satisfaction and improved consumer retention.

Another advantage of the present invention is that consumer preference information for multiple providers is centralized so that it can be readily accessed at any of a number transaction sites.

Another advantage of the present invention is that a method, executable code, and system are provided that facilitate a consumer's participation in the collection of preference information.

Yet another advantage of the present invention is that knowledge of consumer preferences enables a provider to create incentives for carrying out transactions that are aligned with the consumers' preferences.

The above and other advantages of the present invention are carried out in one form by a method for facilitating execution of a transaction between a consumer and a provider. The method calls for storing preference data in a database, the preference data being defined by the consumer, detecting a request for the transaction at a transaction site of the provider, and utilizing a consumer identifier for the consumer at the transaction site to retrieve the preference data from the database. The preference data identifies a product offered by the provider and, preferred by the consumer. A transaction is performed at the transaction site to provide the product to the consumer in response to the retrieved preference data.

The above and other advantages of the present invention are carried out in another form by a computer-readable storage medium for facilitating execution of a transaction between a consumer and a provider. The computer-readable storage medium includes a data storage element having a database stored therein and executable code. The executable code instructs a processor to perform operations that include storing preference data defined by the consumer in the database. The storing operation calls for determining a selection. by the consumer of providers from the index, the provider being one of the providers. The preference data particular to each of the providers is captured from the consumer. The preference data received from the consumer is collated in the database for the providers and is associated with the consumer identifier of the consumer. The executable code further instructs the processor to perform further operations that include detecting a request for the transaction at a transaction site of the provider, utilizing the consumer identifier for the consumer at the transaction, site to retrieve the preference data from the database, the preference data identifying a product offered by the provider and preferred by the consumer, and providing the preference data to the transaction site to enable the transaction and provide the product to the consumer.

The above and other advantages of the present invention are carried out in yet another form by a system for facilitating execution of a transaction between a consumer and a provider. The system includes a processor, a computer-readable storage medium, a database recorded on the computer-readable storage medium, and executable code recorded on the computer-readable storage medium. The computer-readable storage medium instructs the processor to perform operations that include registering the provider in an index of providers accessible by the consumer and storing preference data particular to the provider in the database. The provider is selected by the consumer from the index of providers and the Preference data is defined by the consumer. The computer-readable storage medium instructs the processor to perform further operations that include detecting a request for the transaction at a transaction site of the provider utilizing a consumer identifier for the consumer entered at the transaction site to retrieve the preference data from the database, the preference data identifying a product offered by the provider and preferred by the consumer, and offering an incentive to the consumer to engage in the transaction, the incentive being formed in response to the preference data. The preference data is provided to the transaction site to enable the transaction and provide the product to the consumer.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a schematic layout diagram of a network of computing systems in which the present invention may be implemented;

FIG. 2 shows a block diagram of a computing system, and in particular an administrator system with a database in accordance with the present invention;

FIG. 3 shows an image of a provider database of the present invention;

FIG. 4 shows an image of a consumer database of the present invention;

FIG. 5 shows a flowchart of provider registration process;

FIG. 6 shows a screen shot image of a provider portal in accordance with the present invention;

FIG. 7 shows a flowchart of a consumer preference data storage process;

FIG. 8 shows a partial screen shot image of a login screen of a consumer portal in accordance with the present invention;

FIG. 9 shows a partial screen shot image of a provider selection screen of the consumer portal;

FIG. 10 shows a partial screen shot image of a product selection screen of the consumer portal;

FIG. 11 shows a partial screen shot image of a product customization screen of the consumer portal;

FIG. 12 shows a flowchart of a transaction process in accordance with the present invention; and

FIG. 13 shows an image of an exemplary response that may be communicated from an administrator system to a transaction system within the network of computing systems.

### DETAILED DESCRIPTION OF THE PREFERRED EMBODIMENTS

The present invention entails methodology, executable code and a system for facilitating the execution of a transaction between a provider and a consumer in order to provide a product to the consumer. More particularly, the Present invention effectively collects and utilizes consumer preference information so that a provider can provide a personalized, consistent, quality transaction experience to a consumer within the context of a transaction site.

In a particular embodiment, the present invention entails a third-party active database storage system that acts as an intermediate agent or proxy between consumers and providers. Methodology associated with the database storage system entails the registration or subscription of providers into the system. In addition, consumers are able to utilize the system to define preference data associated with the subscribing providers. This preference data can be made available at transaction sites (brick-and-mortar and/or toe Internet) when consumers are conducting business with providers subscribed to the service. Such an approach encourages a more intimate relationship between providers and consumers so as to encourage consumer retention and acquisition rates and ultimately increase growth, revenue, and profit opportunities for the providers.

The following is a glossary of terminology used herein:

Provider: is a company, business, vender, merchant, electronic commerce media website, service provider, and the like that promotes and exchanges goods and/or services for money.

Consumer: is an individual or entity that purchases or otherwise utilizes the goods and/or services offered by the provider.

Transaction: is an exchange or transfer of product.

Product: goods, services, funds, media, and the like offered by the provider.

Transaction Site: is a “brick-and-mortar” facility, computer within the context of e-commerce, an automated self-serve kiosk, and the like through which the consumer may engage in a transaction with the provider.

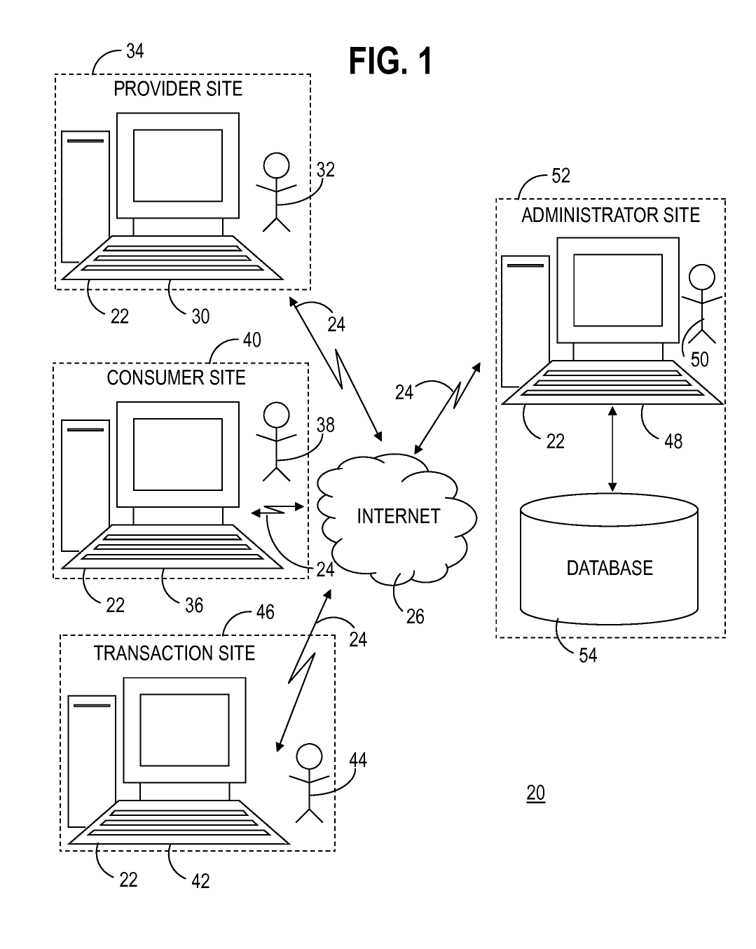

FIG. 1 shows a schematic layout diagram of a network 20 of computing systems 22 in which the present invention maybe implemented. Each of computing systems 22 may be position d at various locations, or sites, within an environment, and each may be operated or managed by an entity or user. Network connections, represented by bidirectional arrows 24, interconnect each of computing systems 22 to a cloud. element 26 representing the Internet and network data paths, i.e., the interconnectivity of comp ting systems 22, through network 20.

For purposes of the present invention, a first one of computing systems 22, referred to hereinafter as a provider system 30, is operated by one of the users, referred to hereinafter as a provider 32, at a provider site 34. A second one of computing systems 22, referred to hereinafter as a consumer system 36, is operated by one of the users, referred to hereinafter as a consumer 38, at a consumer site 40.

A third one of computing systems 22 is referred to hereinafter as a transaction system 42. Transaction system 42 may be a cash register, a computer terminal, a handheld transaction device, and the like, operable by a representative 44 of provider 32 at a transaction site 46. Through the utilization of transaction system 42 at transaction site 46, consumer 38 may engage in a transaction with provider 32 with the assistance of representative 44. Transaction site 46 is represented as a point-of-sale facility for provider 32 and consumer 38 engages in commerce with representative 44 of provider 32 at transaction site 46.

In an alternative embodiment, transaction system 42 may be a computing system and representative 44 may be a website through which consumer 38 may engage in electronic commerce with provider 32 to execute a transaction. Similarly, transaction system 42 may be an automated self-serve kiosk and representative 44 may be an interactive display through which consumer 38 engages in commerce with provider 32 to execute a transaction. The present invention may be adapted for use in connection with various other consumer venues that enable transactions between consumer 38 and provider 32, such as drive-through, walk-up, information outlets, and so forth.

A fourth one of computing systems 22, referred to hereinafter as an administrator system 48, may be operated and maintained by an administrator 50, at an administrator site 52. Administrator system 48 further includes a database 54. Administrator system 48 serves as a centralized management system for managing the implementation of processes related to facilitating the execution of a transaction between consumer 32 and provider 44. As will be discussed in greater detail below, administrator system 48 includes the executable code and memory capacity to manage an exchange of information between each of provider system 30, consumer system 36, and transaction system 42 with database 54.

Only one provider 32, consumer 38, and representative 44 with their related sites 34, 40, and 46, and their related computing systems 30, 36, and 42 are shown in network 20 for simplicity of illustration. It should be understood, however, that network 20 includes many more providers 32, consumers 38, and representatives 44 then that which is shown.

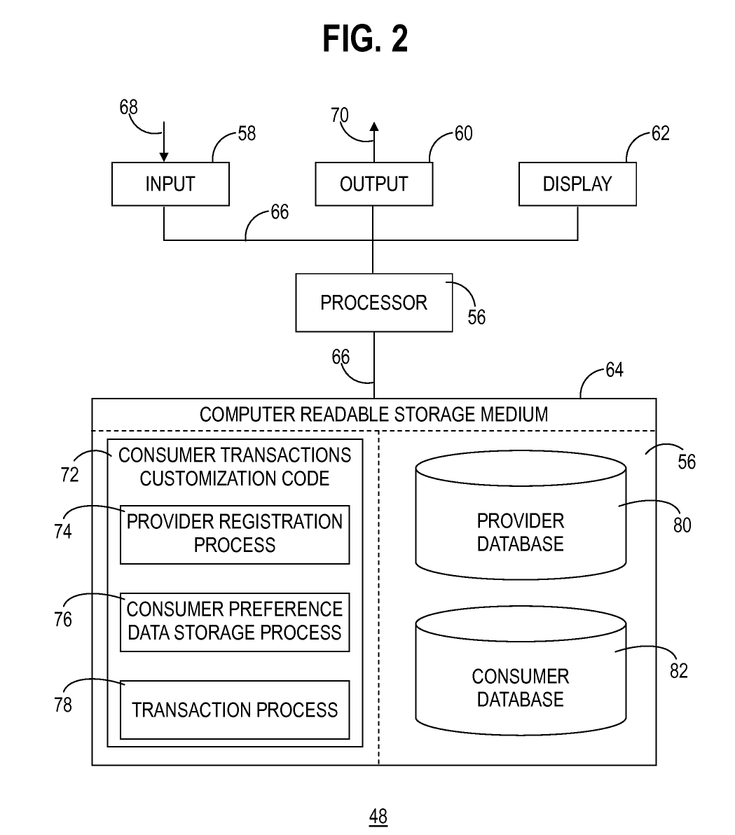

FIG. 2 shows a block diagram of a computing system, and in particular, administrator system 48 with database 54, in accordance with the present invention. Administrator system 48 includes a processor 56 on which the methodology according to the invention can be practiced. Processor 56 is in communication with an input device 58, an output device 60, a display 62, and a computer readable storage medium. 64. These elements are interconnected by a bus structure 66.

Input device 58 can encompass a keyboard, mouse, pointing device, audio device (e.g., a microphone), and/or any other device providing input 68 to processor 56. Output device 60 can encompass a printer, an audio device (e.g., a speaker), and/or other devices providing output 70 from processor 56, and display 62 presents information in visual form. Administrator system 48 can also include network connections, modems, or other devices used for communications with other computer systems or devices via Internet 26 (FIG. 1).

Computer-readable storage medium 64 may be a magnetic disk, optical disk, compact disk, or any other volatile or non-volatile mass storage system readable by processor 56. Computer-readable storage medium 64 may also include cooperating or interconnected computer readable media, which exist exclusively on administrator system 48 or are distributed among multiple interconnected computer systems (not shown) that may be local or remote.

Consumer transactions customization code 72 is recorded on computer-readable storage medium 64 for instructing processor 56 to facilitate the execution of a transaction between consumer 38 (FIG. 1) and provider 32 (FIG. 1). Consumer transactions customization code 72 includes executable code in the form of a provider registration process 74, a consumer preference data storage process 76, and a transaction process 78. Database 54 is additionally recorded on computer-readable storage medium 64. Database 54 includes a provider database 80 and a consumer database 82.

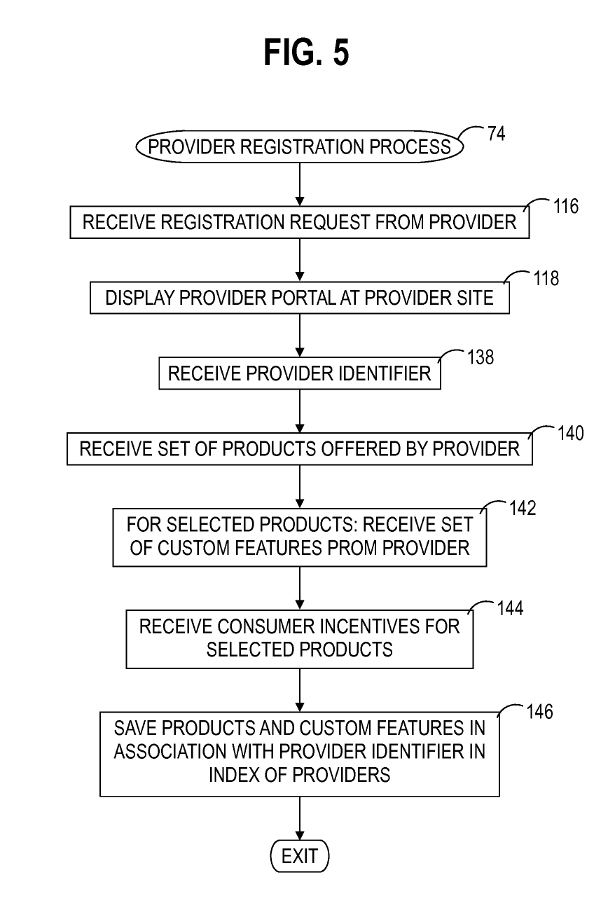

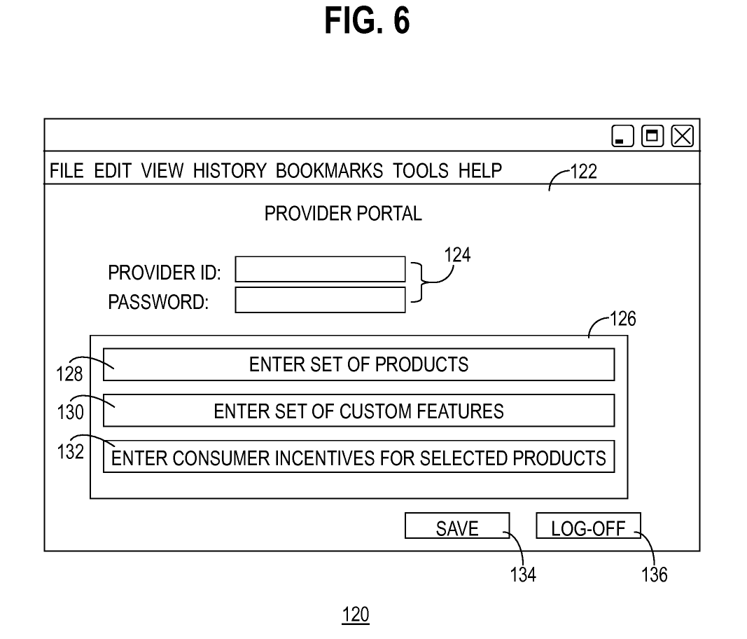

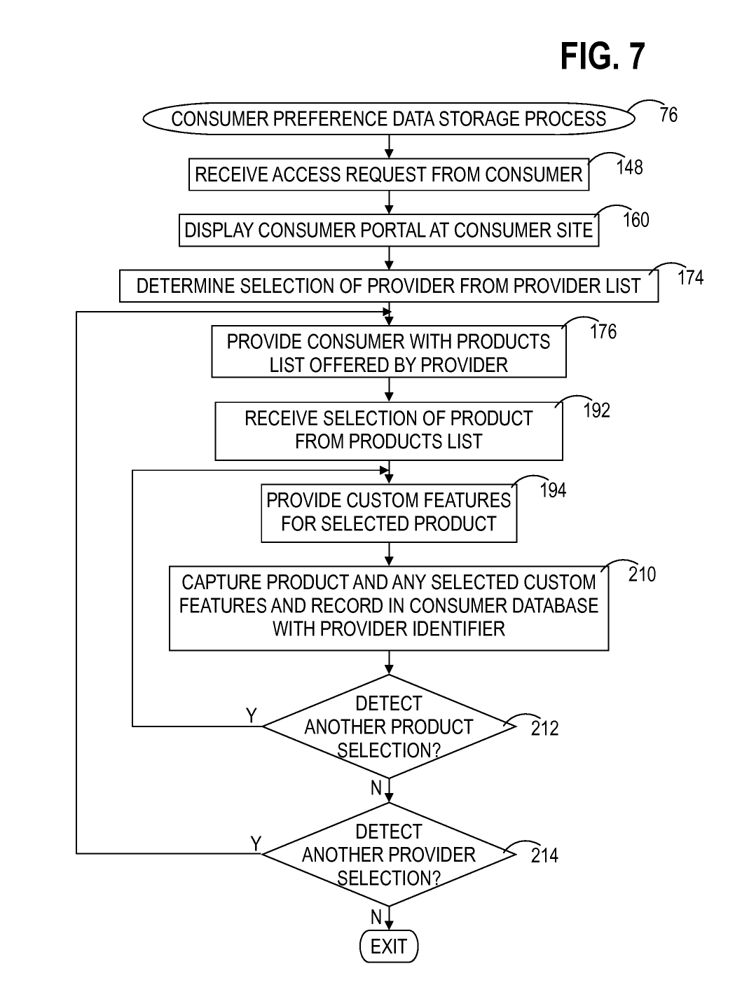

In general, provider registration process 74 of code 72 is executed in response to a registration request from provider system 30 (FIG. 1). Process 74 enables provider 32 to be listed in an index of providers within provider database 80. Through the execution of process 74, provider 32 can list their products for sale, along with custom features, pricing, Purchase incentives, and so forth within provider database 80. Provider registration process 74 is discussed in connection with FIGS. 5 and 6. Consumer preference data storage process 76 of code 72 is executed in response to an access request from consumer system 42. Process 76 enables consumer 38 to create a profile, or set of preference data, of favored providers 32 listed in provider database 80 with preferred products and custom features offered by those favored providers 32. Consumer preference data storage process 76 is discussed in connection with FIGS. 7-11.

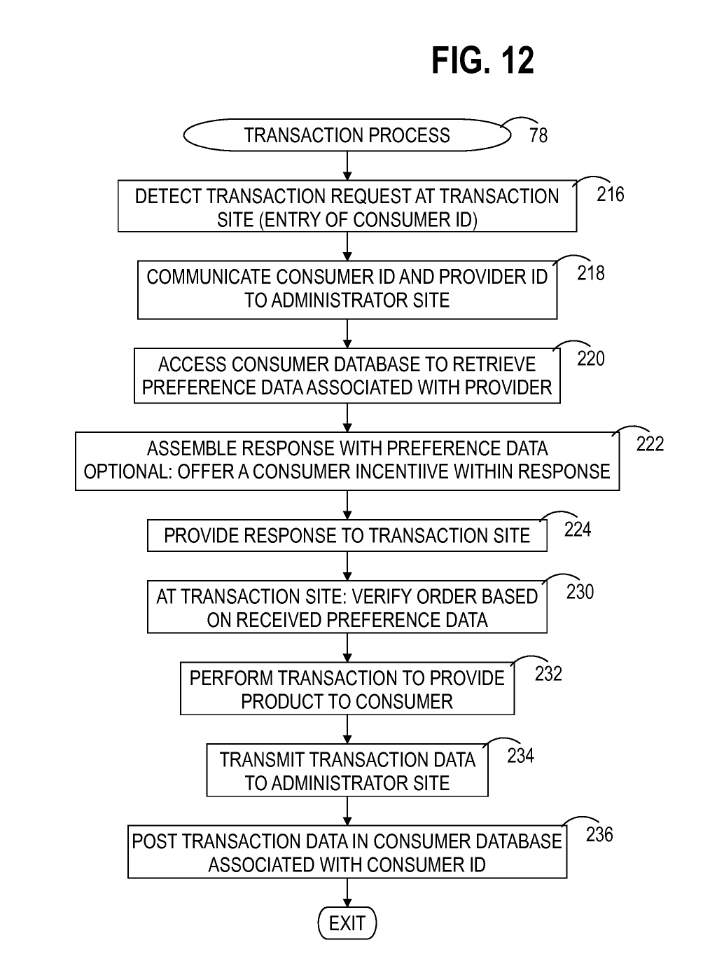

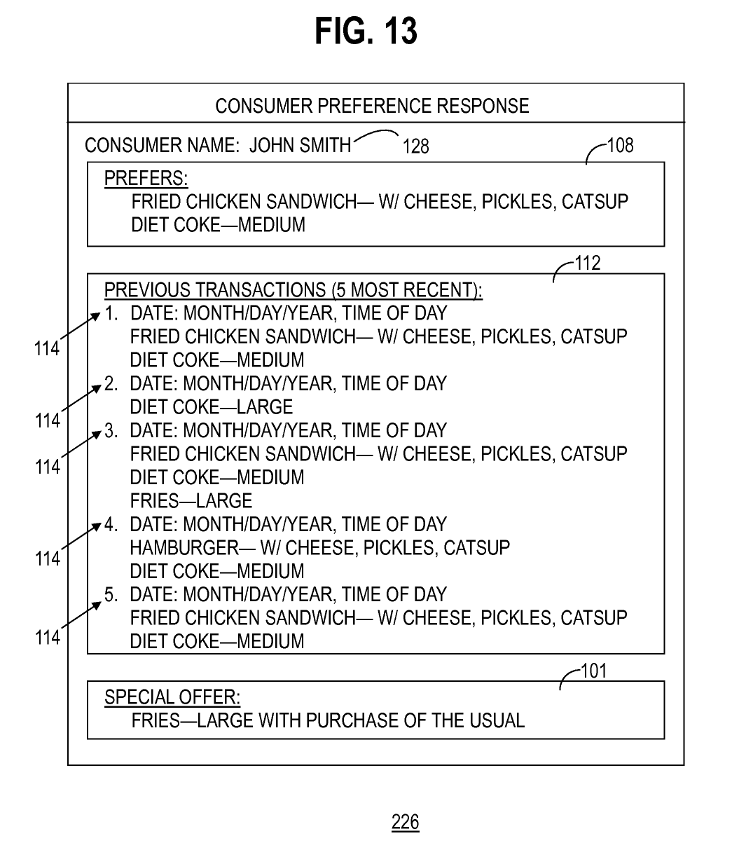

Transaction process 78 facilitates the execution of a transaction between consumer 38 and provider 32 by accessing preference data for favored providers 32 defined by consumer 38 during the course of the transaction. The preference data (discussed below) may be a listing of one or more preferred products that consumer 38 typically orders from provider 32. This preference data can be provided to representative 44 to encourage a personalized shopping experience for consumer 38. Transaction process 78 is discussed in connection with FIGS. 12-13.

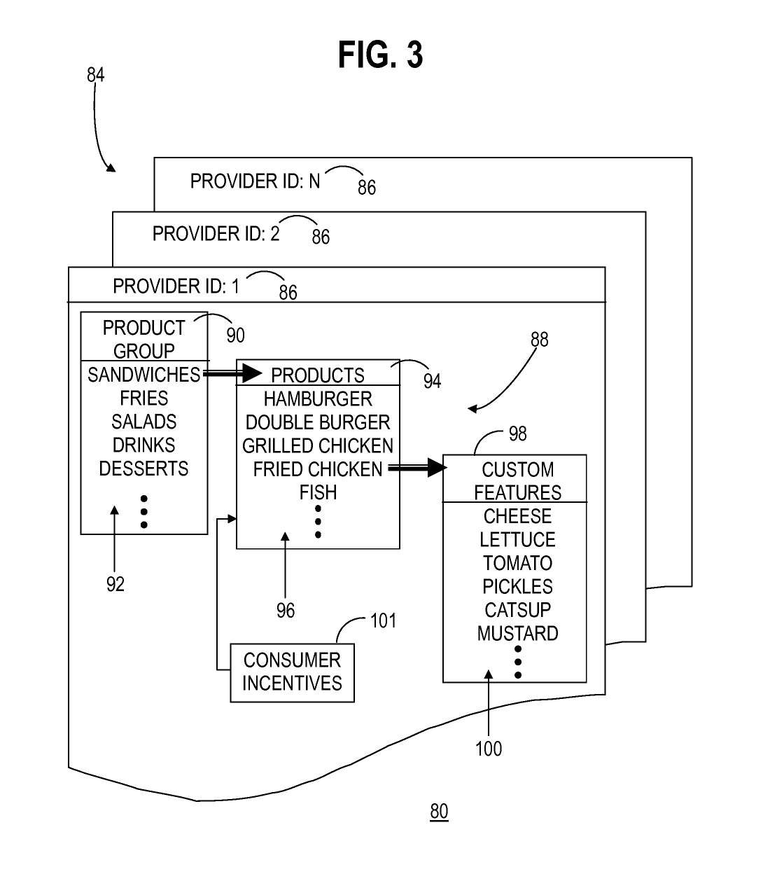

FIG. 3 shows an image of provider database 80 of the present invention. Provider database 80 includes a provider index 84 that is assembled during multiple instances of the execution of provider registration process 74 (FIG. 2) by providers 32 (FIG. 1). Each of providers 32 wishing to be included in provider index 84 is identified by a unique provider identifier 86. Each provider identifier 86 has associated therewith a set 88 of products offered by the corresponding provider 32.

Set 38 of products for a first one of providers 32 identified by provider identifier 86 labeled “Provider ID: 1” is shown. Set 88 of products is generally a hierarchically arranged bill of materials, or “parts list” of products need to complete a saleable end-item. In this exemplary embodiment, set 88 of products includes a first level module 90, labeled “product group.” Selection of one of product groups 92 reveals a second level module 94. Second level module 94 includes products 96 within the selected one of product groups 92. In this exemplary instance, the selected product group 92 is “sandwiches” and products 96 listed within “sandwich” product group 92 include, for example, hamburger, double burger, grilled chicken, fried chicken, fish, and so forth.

At the discretion of provider 32 identified by provider identifier 86, each of products 96 can have a set of custom features associated with it. By way of example, selection of on of products 96 at second level module 94 reveals a third level, module 98. Third level, module 98 includes custom features 100 that may be selected by consumer (FIG. 1) during the execution of consumer preference data storage process 76 (FIG. 2). In this exemplary instance, the selected one of products 96 is “fried chicken” and custom features 100 listed within third level module 94 in connection with “fried chicken” product 96 include, for example, cheese, lettuce, tomato, pickles, catsup, mustard, and so forth.

At the further discretion of provider 32, some or all or products 96 can have consumer incentives 101 associated with them. Consumer incentives 101 can include price discounts, free offers, quantity discounts, and the like that encourage consumer 38 to purchase a particular product 96 or products.

Only one set 88 of products for a first one of providers 32 identified by provider identifier 86 labeled “Provider ID: 1” is shown herein for simplicity of illustration. Of course, this discussion can be expanded to encompass any number of providers 32 included in provider index 84. In addition, it should be readily apparent that set 88 can include any number and variety of products 96 and custom features 100 offered by a particular one of providers 32. This extensive information is represented in provider database 80 by ellipses. Moreover, set 88 of products can be organized in a multitude of ways in accordance with database organization schema.

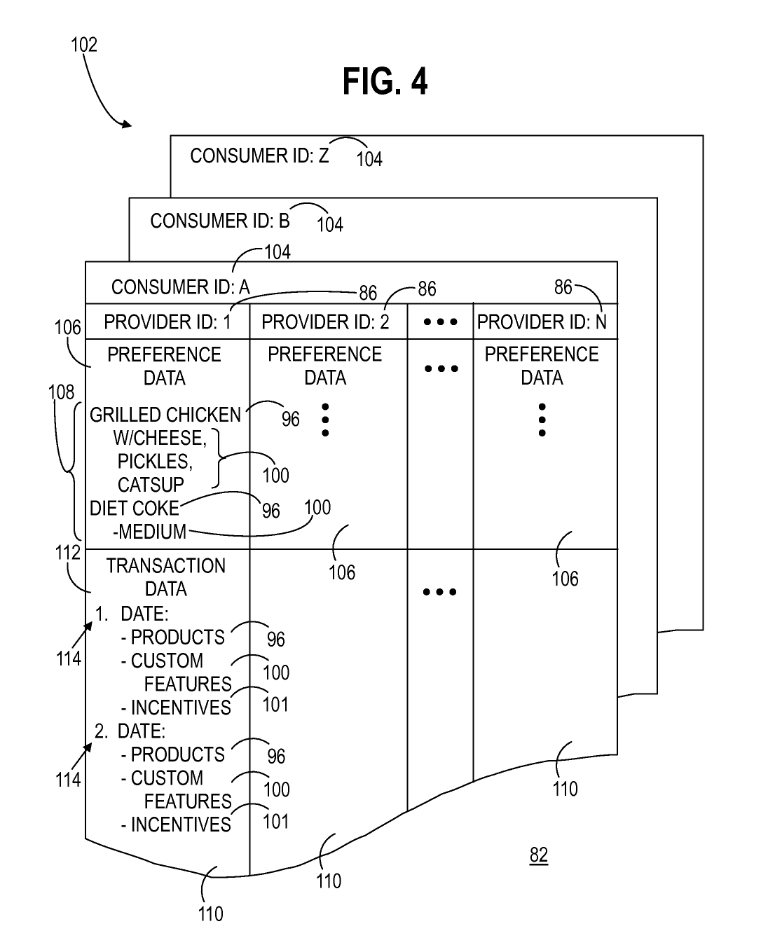

FIG. 4 shows an image of consumer database 82 of the present invention. Consumer database 82 includes a consumer index 102 that is assembled during multiple instances of the execution of consumer preference data storage process 76 (FIG. 2) by multiple consumers 38 (FIG. 1). Each of consumers 38 who wishes to have their product preference data saved in association with particular providers 32 (FIG. 1) is identified by a unique consumer identifier 104. Each consumer identifier 104 has associated therewith a compilation of preference data for one or more providers 32.

In this exemplary embodiment, consumer database 82 includes a number of preference fields 106, each of which is associated with a unique provider identifier 86 identifying one of providers 32. Each of preference fields 106 includes preference data 108. Preference data 108 includes one or more products 96 and optionally, custom features 100, offered by the associated one of providers 32 and preferred by that consumer 38. Preference data 108 was voluntarily defined by each of consumers 38 identified by consumer identifiers 104, during the execution of consumer preference data storage process 76 (FIG. 2), the details of which are discussed below.

Consumer database 82 may further include a number of transaction fields 110, each of which is associated with a particular one of provider identifiers 86. Each transaction field 110 includes transaction data 112. Transaction data 112 includes zero or more instances of transactions 114 that, have taken place between this provider 32 and this consumer 38 through transaction site 46 (FIG. 1). Transaction data 112 for each of transactions 114 may include, for example, a transaction date with products 96 that were purchased, along with any custom features 100 and/or consumer incentives 101. Transaction data 112 may be automatically collected during the execution of transaction process 78 (FIG. 2), the details of which are discussed below.

Only preference data 108 and transaction data 112 for one of providers 32 (labeled “Provider ID: 1”) for a first one of consumers 38 (labeled “Consumer ID: A”) is shown herein for simplicity of illustration. Of course, this discussion can be readily expanded to encompass any number of consumers 38 and their preference data 108 and transaction data 112 in consumer database 82. This extensive information is represented in consumer database 82 by ellipses Moreover, consumer database 82 can be organized in a multitude of ways in accordance with database organization schema.

FIG. 5 shows a flowchart of provider registration process 74. As mentioned briefly above, provider registration process 74 of consumer transactions customization code 72 (FIG. 2) enables provider 32 (FIG. 1) to be listed in provider index (FIG. 3) within provider database 80 (FIG. 3). Through the execution of process 74, provider 32 can list their products for sale, along with custom features 100 (FIG. 3), pricing, consumer incentives 101 (FIG. 3), and so forth within provider database 80.

Process 74 begins with a task 116. At task 116 administrator system 48 (FIG. 1) receives a registration request from provider 32. For example, provider 32 may access a website managed from administrator site 52 (FIG. 1) in order to register. An initial registration request may entail an exchange of provider verification data, such as business name, contact information, location, payment information, establishment of a provider name and password, and so forth as known to those skilled in the art. Any subsequent registration requests may merely entail entry of the provider name and password. Following a successful registration, or login attempt, process 74 continues with a task 118.

At task 118, a provider portal maintained from administrator site 52 is displayed on provider system 30 (FIG. 1).

Referring to FIG. 6 in connection with task 118, FIG. 6 shows a screen shot image 120 of a provider portal 122 presented to provider 32 in accordance with the present invention. Provider portal 122 is a website managed from administrator system 52 that provides personalized capabilities to provider 32 and provides means for enabling provider 32 to save provider information in provider database 80. Provider portal 122 is displayed on provider system 30 at provider site

In an exemplary scenario, provider portal 122 may include provider identifier and password entry fields 124 and a provider menu 126. Fields 124 and provider menu 126 are provided on the same screen shot image 120 for simplicity of illustration. However, those skilled in the art will readily recognize that provider menu 126 may not be displayed until provider 32 has successfully logged in, at which time provider identifier and password entry fields 124 would no longer be displayed.

Provider menu 126 may include selectable text or icons that enable provider 32 to enter the desired provider information. For example, provider portal 122 includes selectable text in the form of product entry text 128, “Enter Set of Products,” custom features entry text 130, “Enter Set of Custom Features for Selected Products,” and incentive entry text 132, “Enter Consumer Incentives for Selected Products.” A “save” selectable icon 134 enables provider 32 to save any desired information, and a “log-off” selectable icon 136 provides means for enabling provider 32 to log-off or complete a current execution of provider registration process 74.

In general, provider portal 122 enables provider 32 to enter set 88 (FIG. 3) of products 96 (FIG. 3) offered by provider 32 for storage in provider database 80 (FIG. 2). Those skilled in the art will recognize that provider portal 122 can take on a great variety of appearances and can include more or less features than that which is shown.

With continued reference to FIGS. 5 and 6, in response to task 118, provider registration process 74 continues with a task 138. At task 138, administrator system 48 receives provider identifier 86 (FIG. 3) particular to provider 32 (FIG. 1).

Process 74 continues with a task 140. At task 140, administrator system 48 receives set 88 (FIG. 3) of products 96 offered by provider 32. For example, provider 32 may select product entry text 128 at provider portal 122 to enter set 88 of products. In an exemplary embodiment, set 88 of products 96 may be electronically transferred from a database (not shown) maintained by provider system 30 via. Internet 26 (FIG. 1). However, in another embodiment, set 88 of products 96 may be manually entered by provider 32. Upon receipt, administrator system 48 may organize, format, or otherwise condition set 88 of products 96.

A task 142 is performed in connection with task 140. At task 142, administrator system 48 receives a set of custom features 100 (FIG. 3) for products 96 (FIG. 3) selected from set 88 of products 96. For example, provider 32 may select custom feature entry text 130 at provider portal 122 to enter custom features 100. Custom features 100 may be defined for all products 96 within set 88 of products 96.

Alternatively, custom features 100 maybe defined for a subset of products 96 or none of products 96 from set 88 of products 96 in accordance with the type of products 96 offered by provider 32. Upon receipt, administrator system 48 may organize, format, or otherwise condition custom features 100 in association with products 96.

A task 144 may also be performed in connection with tasks 140 and 142. At task 144, administrator system 48 receives consumer incentives 101 (FIG. 3) for selected ones products 96 within set 88 of products 96. For example, provider 32 may associate a price discount or percentage discount to certain products 96, may offer buy-one-get-one free incentives, and the like. Upon receipt, administrator system 48 may organize, format, or otherwise condition consumer incentives 101 for association with products 96.

In response to tasks 140, 142, and 144, administrator system performs a task 146. At task 146, administrator system 48 saves set 88 of products 96 (FIG. 3), heir associated custom features 100, and consumer incentives 101 in provider index 84 (FIG. 3) of provider database 80 (FIG. 2) in association with provider identifier 86. Task 146 may be initiated when provider 32 actuates “save” icon 134 within provider portal 122. Once saved, provider 32 can discontinue, or exit, process 74 by actuating “log-off” icon 136 within provider portal 122. Provider 32 can repeat execution of process 74 as needed to add and/or remove products 96 from provider database 80 (FIG. 3).

FIG. 7 shows a flowchart of consumer preference data storage process 76. Consumer preference data storage process 76 enables consumer 38 to create a profile, or preference data 108 (FIG. 4), of favored providers 32 listed in provider database 80 with preferred products 96 (FIG. 3) and custom features 100 (FIG. 2) offered by those favored providers 32.

At task 148, administrator system 48 (FIG. 1) receives an access request from consumer 38 (FIG. 1). For example, consumer 38 may access a website managed from administrator site 52 (FIG. 1). An initial access request may entail an exchange of consumer verification data, such as name, address, telephone number(s), e-mail address, establishment of a consumer name and password, and so forth as known to those skilled in the art. Any subsequent access requests may merely entail entry of the provider name and password.

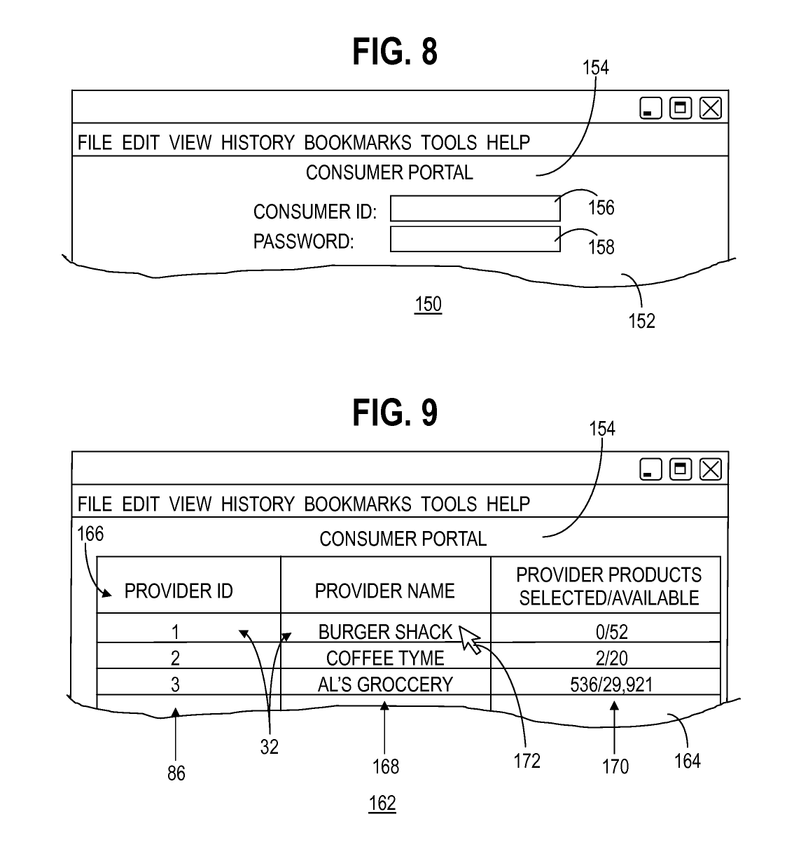

Referring to FIG. 8 in connection with task 148, FIG. 8 shows a partial screen shot image 150 of a login screen 152 of a consumer portal 154 in accordance with the present invention. Consumer portal 154 is a website managed from administrator system 52 that provides personalized capabilities to consumer 38 and provides means for enabling consumer to generate preference data 108 (FIG. 4) to be stored in consumer database 82 (FIG. 4). Login screen 152 of consumer portal 154 may be displayed on consumer system 36 (FIG. 1) at consumer site 40. In an exemplary scenario, login screen 152 may include a consumer identifier entry field 156 and a password entry field 158. Fields 156 and 158 enable secured login for consumer 38 per convention.

With reference back to FIG. 7, following a successful login attempt at task 148, process 76 continues with a task 160. At task 160, a provider list maintained from administrator site 52 is displayed via consumer portal 154 on consumer system 36 (FIG. 1).

Referring to FIG. 9 in connection with task 160, FIG. 9 shows a partial screen shot image 162 of a provider selection screen 164 via consumer portal 154. Provider selection screen 164 includes a provider list 166 corresponding to provider index 84 (FIG. 3) stored in provider database 80 (FIG. 3). Provider list 166 contains a list of providers 32 (FIG. 1) each of which is represented by unique provider identifier 86 and a provider name 168. Provider list 166 may additionally include a quantity field 170 associated with each of providers 32 in provider list 166. Quantity field 170 may include a total quantity of products 96 (FIG. 3) offered by each of providers 32 as well as a quantity selected by consumer (FIG. 2), represented herein as “selected/available.” An arrow-like pointer 172, typically used to show a computer mouse position, may be utilized, to enable consumer 38 to select one of providers 32 presented in provider list 166.

With reference back to consumer preference data storage process 76 of FIG. 7, following display task 160, Process control continues with a task 174. At task 174, a determination is made at administrator system 48 (FIG. 1) that consumer 38 has selected one of providers 32 from provider list 166. Selection may be determined from conventional point and click activities executed by consumer 38 using pointer 172 (FIG. 9).

In response to task 174, a task 176 is performed. At task 176, consumer 38 is provided with set 88 (FIG. 3) of products 96 (FIG. 3) offered by the selected provider 32 via consumer system 36 (FIG. 1).

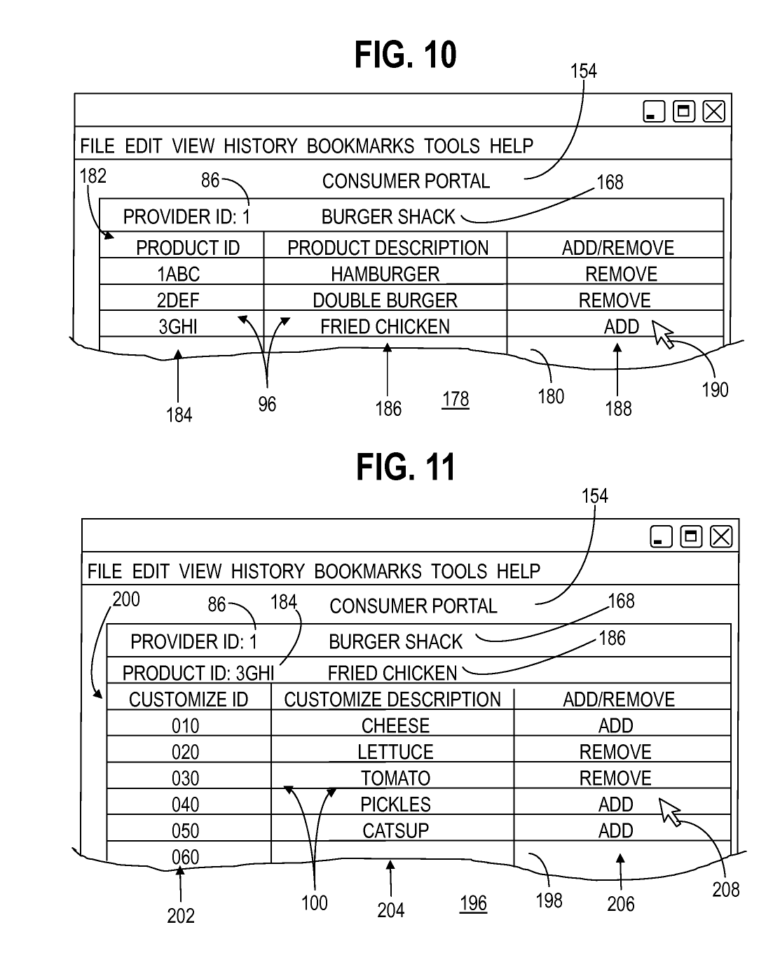

Referring to FIG. 10 in connection with task 176, FIG. 10 shows a partial screen shot image 178 of a product selection screen 180 provided via consumer portal 154. Product selection screen 180 includes provider identifier 86 and provider name 168, labeled “Burger Shack,” representing the selected one of providers 32 (FIG. 1). Product selection screen 180 further includes a product list 182 corresponding to set 88 of products 96 stored in provider database 80 (FIG. 3). Product list 182 contains a catalog of products 96 offered by the selected one of providers 32, each of which is represented by a unique product identifier 184 and a product description 186.

Product list 182 further includes a selection field 188 associated with each of products 96. Selection field 188 is utilized by consumer 38 to select, i.e., “ADD” those products 96 to be included within consumer's preference data 108 (FIG. 4) for that provider 32, and to de-select, i.e., “REMOVE” those products 96 that are not to be included within preference data 108. In one embodiment, selection field 188 for all products 96 presented in product list 182 may default to “REMOVE” unless otherwise selected, i.e. ADD, via conventional consumer initiated point and click activities using a pointer 190.

Referring back to process 76 illustrated in FIG. 7, in response to provision task 176, a task 192 is performed. At task 192, administrator system 48 receives the selection from consumer 38 of one or more products 96 offered by provider 32. Selection may be determined at task 192 from conventional point and click activities executed by consumer 38 using pointer 190 (FIG. 10). Referring briefly to FIG. 10, it should be noted that in this exemplary scenario consumer 38 selected, e.g., “ADD,” one of products 96, whose product description 186 is “fried chicken.”

Following to 192, a to 194 may be performed. At task 194, custom features 100 (FIG. 3) for the selected product 96, e.g., “fried chicken” is provided. That is, consumer 38 is provided with custom features 100 associated with the selected one of products 96 offered by the selected provider 32 is consumer system 36 (FIG. 1).

Referring now to FIG. 11 in connection with task 194, FIG. 11 shows a partial screen shot image 196 of a product customization screen 198 provided via consumer portal 154. Customization screen 198 includes provider identifier 86 and provider name 168, labeled “Burger Shack,” represent the selected one of providers 32 (FIG. 1). Customization screen 198 also includes product identifier 184 and product description 186, labeled “fried chicken,” representing the selected one of products 96.

Customization screen 198 further includes a custom features list 200 corresponding to custom features 100 stored in provider database 80 (FIG. 3). Custom features list 200 contains a catalog of custom features 100 offered by the selected one of providers 32 for the selected one of products 96, each of which is represented by a unique customize identifier 202 and a customize description 204.

Custom features list 200 further includes a selection field 206 associated with each of custom features 100. Like selection field 188 (FIG. 10) of product list 182 (FIG. 10), selection field 206 is utilized by consumer 38 to select, i.e., “ADD” those custom features 100 to be included within consumer's preference data 108 (FIG. 4) for that provider 32, and to de-select, i.e., “REMOVE” those custom features 100 that are not to be included within preference data 108. In one embodiment, selection field 206 for all custom features 100 presented in product list 182 may default to “REMOVE” unless otherwise selected, i.e. ADD, is conventional consumer initiated point and click activities using a pointer 208.

Referring back to process 76 illustrated in FIG. 7, in response to provision task 194, a task 210 is performed. At task 210, administrator system 48 captures the selection of product 96 and any custom features 100 selected by consumer 38 (FIG. 1). A listing for product 96 and any custom features 100 is recorded in consumer database 82 (FIG. 4) as preference data 108 (FIG. 4) in association with provider identifier 86 (FIG. 4).

The capture of product 96 and custom features 100 may be initiated at task 210 from conventional point and click activities executed by consumer 38 using pointer 208 (FIG. 11). Referring briefly to FIG. 10, it should be noted that in this exemplary scenario consumer 38 selected, e.g., “ADD,” one of products 96, whose product description 186 is “fried chicken.” Referring briefly to FIG. 11, is should be no that for the selected product 96, “fried chicken,” selected custom features 100 include “cheese,” “pickles,” and “catsup.”

Following task 210, consumer preference data storage process 76 continues with a query task 212. At query task 212, administrator system 48 determines whether another one of products 96 (FIG. 3) is selected from product list 182 (FIG. 10). That is, consumer 38 is able to determine whether he or she wishes to have additional products 96 included in preference data 108 (FIG. 4) for the select provider 32. For example, following capture and recordation task 210, consumer may again be presented with screen shot image 178 (FIG. 10) so as to optionally select another of products 96 from product list 182.

When selection of another product 96 is detected at query task 212, process control loops back to task 194 where custom features 100 for the selected product 96 are provided and product 96 and its associated custom features 100 can be recorded as preference data 108 in consumer database 82 (FIG. 4). However, when selection of another product 96 is not detected at query task 212, process 76 continues with a query task 214.

At query task 214, administrator system 48 determines whether another one of providers 32 (FIG. 1) is selected from provider list 166 (FIG. 9). That is, consumer 38 is able to determine whether he or she wishes to generate preference data 108 (FIG. 4) for other providers 32 that are included in provider list 166, corresponding to provider index (FIG. 3) of provider database 80 (FIG. 3). For example, when selection. of another product 96 is not detected at query task 212, consumer may again be presented with screen shot image 162 (FIG. 9) so as to optionally select another of providers 32 from provider list 166.

When selection of another provider 32 is detected at query to 214, process control loops back to task 176 where one or more products 96 and custom features 100 for the selected provider 32 can be selected, captured, and recorded as preference data 108 in consumer database 82 (FIG. 4). However, when selection of another provider 32 is not detected at query task 214, process 76 exits. For example, consumer 38 can discontinue, or exit, process 76 by actuating a “log-off” icon. (not shown) within consumer portal 154.

Thus, execution of consumer preference data storage process 76 allows consumer 38 to compile preference data 108 (FIG. 4) for one or more providers 32 (FIG. 1). This preference data 108 can be goods and/or services that consumer 38 prefers. Consumer 38 can repeat execution of process 76 as desired to modify, add, or remove preference data 108 associated with particular providers 32. Preference data 108 from consumer database 82 (FIG. 4) can subsequently be accessed at any of transaction sites 46 (FIG. 1) when consumer 38 is conducting business with representative 44 (FIG. 1) for those providers 32 included in consumer database 82 (discussed below).

FIG. 12 shows a flowchart of transaction process 78 in accordance with the present invention. Transaction process 78 facilitates the execution of a transaction 114 (FIG. 4) between consumer 38 and provider 32 by accessing preference data 108 (FIG. 4) during the course of transaction 114 that is associated with provider 32 and was previously defined by consumer 38. Transaction process 78 merely describes the execution of a single transaction 114 between provider 32 and consumer 38. Of course, transaction process 78 is executed a plurality of times by a plurality of providers 32 and consumers 38 subscribing to the service and whose information. is recorded in provider database 80 (FIG. 3) and consumer database (FIG. 4), respectively. Transaction process 78 is discussed in connection with a transaction taking place when consumer 38 and representative 44 (FIG. 1) are engaged in commerce at transaction site 46 (FIG. 1), which, in this example, is a brick-and-mortar facility. However, transaction process 78 is readily adapted to include transactions taking place in connection with e-commerce, automated self-serve kiosks, and so forth.

Transaction process 78 begins with a task 216. At task 216, transaction system 42 (FIG. 1) at transaction site 46 detects a transaction request. A transaction request may be detected through the entry in transaction system 42 of consumer identifier 104 (FIG. 4) in the form of an entered number, barcode entry, magnetic code entry, and the like.

In response to task 216, a task 218 is performed. At task 218, transaction system 42 communicates consumer identifier 104 and its provider identifier 86 (FIG. 3) to administrator system 48 (FIG. 1) at administrator site 52 (FIG. 1).

Next, a task 220 is performed at administrator system 48. At task 220, consumer database 82 (FIG. 4) is accessed to retrieve preference data 108 (FIG. 4) associated with provider 32 and defined by consumer 38.

A task 222 is performed in connection with task 220. At task 222, administrator system 48 assembles a response that includes preference data 108. Administrator system 48 may optionally offer consumer incentive 101 (FIG. 3) within the response.

Following task 222, a task 224 is performed by administrator system 48 to provide the response to transaction system 42 at transaction site 46 (FIG. 1).

Referring to FIG. 13 in connection with task 224, FIG. 13 shows an image of an exemplary response 226 that may be communicated from administrator system 48 to transaction system 42. Response 226 includes a consumer name 22A for consumer 38, preference data 108, transaction data 112, and a consumer incentive 101. Response 226 can be utilized by representative 44 to personalize their service to the particular consumer 38. Response 226 is highly simplified for ease of illustration. However, those skilled in the art will recognize that response 226 can include more or less information then that which is shown, and can be presented in various configurations.

Following provision of response 226 at task 224, process 78 continues with a task 230. In accordance with task 230, representative 44 at transaction site 46 verifies consumer's order based upon preference data 108. For example upon receipt of response 226 representative 44 can welcome consumer 38 by name and can ask whether consumer 38 wishes to order the “usual” as specified within preference data 108. Representative 44 can also direct conversation toward products 96 purchased during previous transactions 114, as shown within transaction data 112, and/or representative 44 can inform consumer 38 of any special offers, i.e., consumer incentives 101.

A task 232 is performed in response to task 230. At task 232, representative 44 and consumer 38 perform a transaction 114 to provide product(s) 96 as verified at task 230. For example, in a purchase scenario, consumer 38 may pay representative 44 for product (s) 96 and subsequently receive product (s) 96 from representative 44.

Following performance of transaction 114 at task 232, transaction process 78 may continue with a task 234. At task 234, transaction data 112 (FIG. 3) particular to the just executed. transaction 114 (FIG. 13) is transmitted to administrator site 52.

A task 236 is performed in cooperation with task 234. At task 236, transaction data 112 particular to the just executed transaction 114 is posted in consumer database 82 (FIG. 4) in association with consumer identifier 104 (FIG. 4). This transaction data 112 can then be accessed in subsequent transactions, can be utilized by provider 32 for statistical purposes and/or to generate consumer incentives 101 (FIG. 3), and so forth. Following task 236, transaction process 78 exits.

In summary, the present invention teaches of methodology, executable code and a system for facilitating the execution of a transaction between a provider and a consumer. An active database storage system is employed that acts as an intermediate agent or proxy between consumers and providers. Consumer preference data for multiple providers is centralized in this database so that it can be readily accessed at any of a number of transaction sites. In addition, since the database can accommodate consumer preference data for multiple providers, consumers can readily participate in the collection of preference data through a single consumer portal. The present invention enables a provider to offer personalized service to a consumer for enhanced levels of consumer satisfaction and improved consumer retention, and enables a provider to create incentives for carrying out transactions that are aligned with the consumers' preferences.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A computer-readable storage medium for facilitating execution of a transaction between a consumer and a provider comprising:
a data storage element having a database stored therein; and
executable code for instructing a processor to perform operations comprising:
storing preference data in said database, said preference data being captured from said consumer, and said preference data identifying a product offered by said provider that said consumer orders from said provider;
detecting a request for said transaction at a transaction site of said provider;
retrieving said preference data from said database by utilizing a consumer identifier for said consumer;
providing said preference data to said transaction site;
verifying an order, by said consumer, of said product specified within said preference data; and
performing said transaction at said transaction site to provide said product to said consumer.

2. A computer-readable storage medium as claimed in claim 1 wherein said executable code instructs said processor to perform further operations comprising:
receiving an access request from said consumer to access a website containing an index of providers;
determining a selection by said consumer of said provider from said index of providers;
acquiring said preference data via data entry by said consumer in said website capturing; and
associating said preference data with said consumer identifier in said database.

3. A computer-readable storage medium as claimed in claim 2 wherein said executable code instructs said processor to perform further operations comprising:
providing said consumer with a set of products offered by said provider via said website, said product being included in said set of products; and
receiving a selection of said product from said set of products to include in said preference data.

4. A computer-readable storage medium as claimed in claim 3 wherein said executable code instructs said processor to perform further operations comprising:
enabling said consumer to select a custom feature associated with said product; and
recording said custom feature with said product in said preference data.

5. A computer-readable storage medium as claimed in claim 2 wherein said executable code instructs said processor to perform further operations of said retrieving operation comprising:
receiving, from said transaction site, a provider identifier identifying said provider from said index of providers;
accessing said database to obtain said preference data associated with said provider; and
providing said preference data to said transaction site.

6. A computer-readable storage medium as claimed in claim 1 wherein said executable code instructs said processor to perform a further operation comprising registering, prior to said storing operation, said provider in an index of providers accessible by said consumer, said index of providers enabling said consumer to define said preference data particular to said provider.

7. A computer-readable storage medium as claimed in claim 6 wherein said executable code instructs said processor to perform a further operation comprising receiving from said provider a set of products offered by said provider from which said consumer can select at least one of said products to include in said preference data, said product being included in said set of products.

8. A computer-readable storage medium as claimed in claim 7 wherein said executable code instructs said processor to perform a further operation comprising receiving from said provider a set of custom features associated with said set of offered products, said set of custom features enabling said consumer to select at least one of said custom features to include with said at least one of said products in said preference data.

9. A computer-readable storage medium as claimed in claim 1 wherein said executable code instructs said processor to perform further operations comprising:
collating said preference data received from said consumer in said database for a plurality of said providers; and
associating said preference data for said plurality of said providers with said consumer identifier of said consumer.

10. A computer-readable storage medium as claimed in claim 1 wherein said executable code instructs said processor to perform a further operation comprising offering an incentive to said consumer to engage in said transaction, said incentive being formed in response to said preference data.

11. A computer-readable storage medium as claimed in claim 10 wherein, said executable code instructs said processor to perform a further operation of said offering operation comprising applying a discount price to a purchase of said product.

12. A computer-readable storage medium as claimed in claim 1 wherein said executable code instructs said processor to perform a further operation comprising following said performing operation, posting transaction data related to said transaction in said database, said posting operation including recording said transaction data in association with said consumer identifier.

13. A computer-readable storage medium for facilitating execution of a transaction between a consumer and a provider comprising:
a data storage element having a database stored therein; and
executable code for instructing a processor to perform operations comprising:
storing preference data defined by said consumer in said database, said storing operation including:
determining a selection by said consumer of providers from said index, said provider being one of said providers;
capturing, from said consumer, said preference data particular to each of said providers;
collating said preference data received from said consumer in said database for said providers; and
associating said preference data for said providers with said consumer identifier of said consumer;
detecting a request for said transaction at a transaction site of said provider;
utilizing a consumer identifier for said consumer at said transaction site to retrieve said preference data from said database, said preference data identifying a product offered by said provider and preferred by said consumer; and
providing said preference data to said transaction site to enable said transaction and provide said product to said consumer.

14. A computer-readable storage medium as claimed in claim 13 wherein, said executable code instructs said processor to perform further operations of said capturing operation comprising:
providing said consumer with a set of products offered by said provider; and
receiving, from said consumer, a selection of at least one of said products from said set of products to include in said preference data, said product being included in said at least one of said products.

15. A computer-readable storage medium as claimed in claim 14 wherein said executable code instructs said processor to perform further operations of said capturing operation comprising:
enabling said consumer to include a custom feature with said at least one of said products; and
recording said custom feature with said at least one of said products in said preference data.

16. A computer-readable storage medium as claimed in claim 13 wherein said executable code instructs said processor to perform further operations of said utilizing operation comprising:
receiving, from said transaction site, a provider identifier identifying said provider; and
accessing said database to obtain said preference data associated with said provider identifier.

17. A system for facilitating execution of a transaction between a consumer and a provider comprising:
a processor;
a computer-readable storage medium;
a database recorded on said computer-readable storage medium; and
executable code recorded on said computer-readable storage medium for instructing said processor to perform operations comprising:
registering said provider in an index of providers accessible by said consumer;
storing preference data particular to said provider in said database, said provider being selected by said consumer from said index of providers, said preference data being defined by said consumer;
detecting a request for said transaction at a transaction site of said provider;
utilizing a consumer identifier for said consumer entered at said transaction site to retrieve said preference data from said database, said preference data identifying a product offered by said provider and preferred by said consumer; and
offering an incentive to said consumer to engage in said transaction, said incentive being formed in response to said preference data; and
providing said preference data to said transaction site to enable said transaction and provide said product to said consumer.

18. A system as claimed in claim 17 wherein said executable code instructs said processor to perform further operations comprising:
receiving from said provider a set of products offered by said provider from which said consumer can select at least one of said products to include in said preference data, said product being included in said set of products; and
receiving from said provider a set of custom features associated with said set of offered products, said set of custom features enabling said consumer to select at least one of said custom features to include with said at least one of said products in said preference data.
